(19) United States
(12) Patent Application Publication
(10) Pub. No.: US 2026/0271065 A1
(43) Pub. Date: Sep. 10, 2026

(54) CHANNEL ACCESS MANAGEMENT

(71) Applicant: Nokia Technologies Oy, Espoo (FI)

(72) Inventors: Mikhail LIUBOGOSHCHEV, Munich (DE); Mika KASSLIN, Espoo (FI); Kerstin JOHNSSON, Sunnyvale, CA (US); Prabodh VARSHNEY, Dallas, TX (US); Salvatore TALARICO, Sunnyvale, CA (US)

(21) Appl. No.: 19/070,093

(22) Filed: Mar. 4, 2025

(51) Int. Cl. H04W 74/0816; H04W 48/02; H04W 74/08; H04W 74/0833

(52) U.S. Cl. CPC H04W 74/0816; H04W 48/02; H04W 74/085; H04W 74/0875

(57) ABSTRACT

Example embodiments of the present disclosure are directed to channel access management. In a method, a first apparatus determines whether at least one condition for a prioritized enhanced distributed channel access (P-EDCA) contention procedure is satisfied. If the at least one condition is satisfied, the first apparatus initiates the P-EDCA contention procedure to access to a channel. The at least one condition is based on: information of a previous transmission opportunity, a transmission status of a transmission of the first apparatus, and/or a channel contention delay experienced by the first apparatus.

### FIELD

Various example embodiments of the present disclosure generally relate to the field of telecommunication and in particular, to methods, devices, apparatuses and computer readable storage medium for channel access management.

### BACKGROUND

A communication network may serve as a facility that enables communications between two or more communication devices or provides communication devices access to a data network. A mobile or wireless communication network is one example of a communication network. A communication device may be provided with a service by an application server.

Wireless communication networks such as wireless local area network (WLAN) are capable to provide various communication services such as voice, video and messaging for a plurality of clients. In the wireless communication networks, an access point (AP) may provide network connectivity to a plurality of clients such as stations (STAs).

### SUMMARY

In a first aspect of the present disclosure, there is provided a first apparatus. The first apparatus comprises at least one processor; and at least one memory storing instructions that, when executed by the at least one processor, cause the first apparatus at least to: determine whether at least one condition for a prioritized enhanced distributed channel access (P-EDCA) contention procedure is satisfied; and based on the at least one condition being satisfied, initiate the P-EDCA contention procedure to access to a channel, where the at least one condition is based on at least one of: information of a previous transmission opportunity, a transmission status of a transmission of the first apparatus, or a channel contention delay experienced by the first apparatus.

In a second aspect of the present disclosure, there is provided a second apparatus. The second apparatus comprises at least one processor; and at least one memory storing instructions that, when executed by the at least one processor, cause the second apparatus at least to: determine a configuration of at least one condition for initiating a prioritized enhanced distributed channel access (P-EDCA) contention procedure; and transmit, to at least one first apparatus, the configuration of the at least one condition, where the at least one condition is based on at least one of: information of a previous transmission opportunity, a transmission status of a transmission of the first apparatus, or a channel contention delay experienced by the first apparatus

In a third aspect of the present disclosure, there is provided a method. The method comprises: determining, at a first apparatus, whether at least one condition for a prioritized enhanced distributed channel access (P-EDCA) contention procedure is satisfied; and based on the at least one condition being satisfied, initiating the P-EDCA contention procedure to access to a channel, where the at least one condition is based on at least one of: information of a previous transmission opportunity, a transmission status of a transmission of the first apparatus, or a channel contention delay experienced by the first apparatus.

In a fourth aspect of the present disclosure, there is provided a method. The method comprises: determining, at a second apparatus, a configuration of at least one condition for initiating a prioritized enhanced distributed channel access (P-EDCA) contention procedure; and transmitting, to at least one first apparatus, the configuration of the at least one condition, where the at least one condition is based on at least one of: information of a previous transmission opportunity, a transmission status of a transmission of the first apparatus, or a channel contention delay experienced by the first apparatus.

In a fifth aspect of the present disclosure, there is provided a first apparatus. The first apparatus comprises means for determining whether at least one condition for a prioritized enhanced distributed channel access (P-EDCA) contention procedure is satisfied; and means for based on the at least one condition being satisfied, initiating the P-EDCA contention procedure to access to a channel, where the at least one condition is based on at least one of: information of a previous transmission opportunity, a transmission status of a transmission of the first apparatus, or a channel contention delay experienced by the first apparatus.

In a sixth aspect of the present disclosure, there is provided a second apparatus. The second apparatus comprises means for determining a configuration of at least one condition for initiating a prioritized enhanced distributed channel access (P-EDCA) contention procedure; and means for transmitting, to at least one first apparatus, the configuration of the at least one condition, where the at least one condition is based on at least one of: information of a previous transmission opportunity, a transmission status of a transmission of the first apparatus, or a channel contention delay experienced by the first apparatus

In a seventh aspect of the present disclosure, there is provided a computer readable medium. The computer readable medium comprises instructions stored thereon for causing an apparatus to perform at least the method according to the third aspect, or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example backoff procedure according to the enhanced distributed channel access (EDCA) mechanism;

FIG. 2 illustrates an example communication environment in which example embodiments of the present disclosure can be implemented;

FIG. 3 illustrates a flowchart of an example method for channel access management in accordance with some example embodiments of the present disclosure;

FIG. 4A illustrates an example P-EDCA procedure after a long transmission opportunity (TXOP) according to some embodiments of the present disclosure;

FIG. 4B illustrates an example P-EDCA procedure after a short TXOP according to some embodiments of the present disclosure;

FIG. 5 illustrates a flowchart of another example method for channel access management in accordance with some example embodiments of the present disclosure;

FIG. 6 illustrates a flowchart of another example method for channel access management in accordance with some example embodiments of the present disclosure;

FIG. 7 illustrates a flowchart of another example method for channel access management in accordance with some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Institute of Electrical and Electronic Engineers (IEEE) 802.11 standards (such as IEEE 802.11ax standard (also referred to as Wi-Fi 6)), IEEE 802.3 standards, Wi-Fi Alliance Specifications, or any other wireless communication standards, and/or any other protocols either currently known or to be developed in the future. Implementations of the present disclosure may be applied in various communication systems. Given the rapid development in communications, there will of course also be future type communication technologies and systems with which the present disclosure may be implemented. It should not be seen as limiting the scope of the present disclosure to only the aforementioned system.

As used herein, the term “network device” refers to a node in a communication network via which a terminal device accesses the network and receives services therefrom. The network device may refer to an AP, a base station (BS), and so forth, depending on the applied terminology and technology.

The term “terminal device” refers to any end device that may be capable of wireless communication. By way of example rather than limitation, a terminal device may also be referred to as a communication device, a station, a client (device), user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

One of key mechanisms of Wi-Fi technology is an EDCA mechanism. The EDCA mechanism defines a set of rules for stations (STAs) to gain access to a channel and initiate a transmission. The EDCA mechanism in Wi-Fi employs carrier-sense multiple access with collision avoidance (CSMA/CA) to manage channel access. The CSMA/CA relies on a backoff mechanism to manage access to a shared wireless channel.

In a backoff procedure, a station (STA) which has completed its transmission selects a random backoff time. The STA counts down the backoff when the channel is free and keeps the backoff frozen when the channel is busy, regardless of the transmit buffer state. If the STA obtains data to transmit before the backoff timer reaches zero, it will initiate a TxOP once the timer reaches zero. If the STA receives data after backoff counter has reached zero, it can transmit immediately if the channel is considered free. However, if the channel is not free, the STA has to repeat the backoff procedure.

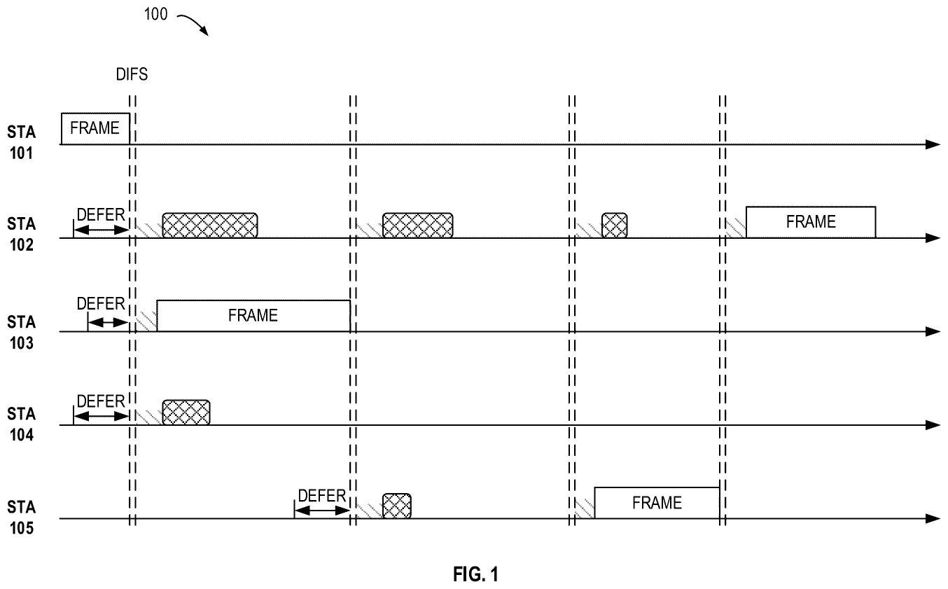

The backoff mechanism procedure may be better understood with respect to FIG. 1, which illustrates an example backoff procedure 100 according to the EDCA mechanism. As shown in FIG. 1, actual frame transmissions are shown as white bars, hypothetical frame transmissions are shown as cross-hatched bar, backoff timers are shown as hatched areas.

At the beginning of the time frame, STA 101 starts its transmission and thus the channel becomes busy. After STA 101 starts transmitting, STA 102, STA 103 and STA 104 detect that the channel is busy and defer their transmissions. The backoff timers of STA 102, STA 103 and STA 104 are frozen while STA 101 transmits. After STA 101 finishes transmitting, STA 102, STA 103 and STA 104 wait for a distributed inter-frame space (DIFS). Then, STA 102, STA 103 and STA 104 count down the backoff. As shown in FIG. 1, STA 103 completes its backoff countdown first and begins its actual transmission. Therefore, the channel becomes busy again, and the hypothetical transmissions of STA 102 and STA 103 do not actually occur. The backoff timer of STA 102 is frozen again while STA 103 transmits.

After STA 103 starts transmitting, STA 105 detects that the channel is busy and defers its transmissions. After STA 103 finishes transmitting, STA 102 and STA 105 wait for a DIFS. Then, STA 102 and STA 105 count down the backoff, and complete their backoff countdown at the same time. In this case, STA 102 and STA 105 initiate transmission opportunities simultaneously, and thus a collision occurs. As a result, neither the hypothetical transmission of STA 102 nor that of STA 105 is successful.

After waiting for another DIFS, STA 102 and STA 105 start their countdown. At this time, STA 105 completes its backoff countdown first and begins its actual transmission. Therefore, the channel becomes busy again, and the hypothetical transmission of STA 102 does not actually occur. STA 102 freezes its backoff countdown when STA 105 transmits. Finally, after the transmission of STA 105 and yet another DIFS, STA 102 starts and completes its countdown, and then STA 102 starts and finishes its transmission.

The STA may select a random backoff time from a defined range, which is referred to as a contention window (CW). For each access category (AC), there is a minimum contention window (CW_min) and a maximum contention window (CW_max). For example, access category voice (AC_VO) may be the highest priority access category and the CW_min may for example be set to ¼th of CW_min for best effort (AC_BE) or background (AC_BK) traffic.

If a collision occurs (multiple devices transmit simultaneously), the contention window size increases exponentially (2× until CW_max is reached) for each subsequent transmission attempt. This gives more time for other devices to transmit and reduces the likelihood of further collisions. This feature may be referred to as exponential backoff.

The EDCA mechanism may further include a randomization feature. The random selection of the backoff time within the contention window helps to reduce the probability of synchronized transmission attempts from multiple devices, further preventing collisions.

The current EDCA mechanism enables differentiated QoS by introducing four access categories (ACs): Voice (AC_VO), Video (AC_VI), Best effort (AC_BE) and Background (AC_BK). The ACs differ by the parameters of the empty channel assessment criteria (AIFSN), and the parameters of the exponential backoff procedure: CW_min and CW_max. The parameters are selected in such a way that gives an advantage to AC_VO traffic by setting lower CW_min and AIFSN values compared to for example AC_VI, AC_BE, AC_BK. However, if a transmission is not successful, a STA has to increase the CW size by a factor of 2. In case of low latency (LL) traffic, the exponential increase in CW size increases the experienced tail latency. The current backoff procedure is effective at handling large numbers of STAs competing for the channel at the same time while avoiding excessive collisions. However, it increases tail latencies and is, therefore, not suitable for low latency STAs.

The task group developing a next-generation Wi-Fi standard (for example, Wi-Fi 8) focuses on reducing communication latency for Wi-Fi STAs running latency-sensitive applications such as Virtual Reality, Mixed Reality and Augmented Reality (XR).

One of the considered topics is the LL support, i.e., delivering frames with low latency for APs and non-AP STAs. This involves modifications to the physical layer (PHY) and medium access control (MAC) that enhance wireless local area network (WLAN) reliability by enabling, in scenarios of an isolated basic service set (BSS) or of overlapping BSSs. The goal is to enable at least one mode of operation capable of increasing throughput, as measured at the MAC data service AP, at different signal to interference and noise ratio (SINR) levels (Rate-vs-Range), compared to Extremely High Throughput MAC/PHY operation, as well as at least one mode of operation capable of improving the tail of the latency distribution and jitter compared to Extremely High Throughput MAC/PHY operation, with mobility between BSSs. Additionally, at least one mode of operation is needed that is capable of improving efficient use of the medium compared to Extremely High Throughput MAC/PHY operation.

One possible approach to supporting LL traffic is to modify the channel access procedure, prioritizing STA(s) with LL traffic. Changes have been proposed to improve the EDCA mechanism to reduce tail access delay of LL traffic in multi-BSS dense scenarios in presence of best effort traffic. This solution employs a distributed approach to improve the EDCA mechanism, and the impact on legacy device(s) would be balanced. In this context, LL traffic would be treated as AC_VO traffic, with other potential cases still under consideration.

Additionally, a prioritized EDCA (P-EDCA) (also referred to as a high priority EDCA (HiP-EDCA)) is being explored where STA(s) with LL traffic could, under specific conditions, be allowed to send a so-called Defer Signal (DS). This would initiate a protected short contention period for pending LL data, although the precise conditions for sending this signal are still to be determined. The solution may involve using request to send (RTS) or clear to send (CTS) for the initial frame exchange and retry. The duration of the protected short contention, along with the access parameters (such as AIFSN, CW and the expansion rules) that are used to transmit the DS, and the retry count where the DS is allowed to be sent, remains under consideration. Contention parameters for the protected short contention would also be refined. STA(s) that fail to win the protected short contention may initiate new retries. In this context, LL traffic would be treated as AC_VO traffic, with other potential cases still under consideration. The approach would provide control on the degree of collisions that may occur while using it and, allows for autonomous randomness or/and controlled by the AP. The solution would not require new mandatory synchronization on the STA side, and the P-EDCA mechanism would be used by STAs in a BSS only when this feature is enabled by the AP.

Currently several P-EDCA schemes have been proposed. The proposals define methods that enable STAs with LL traffic (hereinafter LL STAs) to reserve the channel for LL STAs by sending a DS after the channel state changes from busy to idle and then perform a prioritized channel contention procedure.

This approach allows LL STAs to prevent non-LL STAs from competing for the channel. However, there is no guarantee that the DSs themselves will get through. Moreover, since LL STAs may not always detect when their DSs collide, they assume the collision happened and initiate a contention procedure right after the DS transmission. Different proposals consider different designs of this contention procedure. In the present disclosure, this contention procedure is referred to as “P-EDCA-contention”.

Another point of discussion is P-EDCA eligibility. The conditions under which an LL STA may send the DS are still under discussion. Thus far, the following options are mentioned. First, the P-EDCA procedure should be enabled or disabled in the entire BSS by the AP. Second, STAs should be able to explicitly specify which LL frames may be transmitted using P-EDCA. Third, the DS should only be used when the retry counter (in particular, QoS STA Retry Counter (QSRC)) is positive, i.e., when the LL MAC protocol data unit (MPDU) transmission experiences a collision, the next TXOP carrying this MPDU may start with the DS. Finally, to satisfy the regulatory requirements, the number of DSs sent by a STA should be limited to 50 within a window of 50 ms.

The currently discussed P-EDCA designs do not address several important issues which prevent P-EDCA from reducing the tail delays for frame delivery by the LL-STAs in many important cases. One key challenge is regarding the criteria for P-EDCA eligibility. First, the default assumption is that for a first transmission attempt as well as proceeding transmission attempts during the P-EDCA-contention, LL STAs will access the channel using the most aggressive standard channel access parameters, namely, AC_VO, which has the shortest contention window, CW=CW_min. These parameters minimize channel access delay and maximize the probability that a STA will capture the channel, but at the cost of high collision probability. Two STAs contending for the channel using these parameters would have a 12% collision probability, while 5 STAs would have almost 80% collision probability.

The short AC_VO contention period becomes particularly problematic when multiple LL STAs contend simultaneously. CSMA/CA is known to have challenges when contending devices become synchronized and contend simultaneously. As long as frame arrival to transmit buffers is asynchronous and drives channel contention, collisions are relatively rare also among the high priority ACs. As soon as contending devices become synchronized e.g., due to end of a long transmission, collision probability increases significantly. Multiple LL STAs may have received an LL frame to their transmit buffer during a few milliseconds transmission which may be e.g., a single AC_BE PPDU when TXOP_limit=0 for AC_BE. Without such a long transmission, the LL devices could have obtained TxOP for their own transmission quickly after arrival of the frame to the transmit buffer. End of the long transmission synchronizes all the LL STAs that have received LL data to transmit during the long transmission and they end up contending simultaneously. When LL traffic arrives the Tx buffer of an LL STA during a TxOP of another STA, the STA must wait until the end of that TxOP to contend for the channel. The longer the TxOP, the higher the probability that the LL STAs in the BSS have received traffic by the end of the TxOP. This increases the number of LL STAs contending for the channel at the same time, resulting in high collision probability. Hence, a mechanism to regulate contention after long TxOPs would help reduce collision probability.

Second, current proposals consider the QSRC value as a criterion for P-EDCA contention eligibility. This criterion only prioritizes LL STAs that have experienced a collision. However, a collision is not the only reason why a STA might need priority channel access. For example, it might have lost several channel access opportunities in a row, or its frame was sent previously but wasn't delivered successfully.

Another key challenge is regarding the differentiation between initiating and participating in P-EDCA contention. First, the frame sent within the P-EDCA context are not supposed to differ in any way from the frames sent outside of the P-EDCA. This prevents a LL-STA from detecting that some other LL-STA initiated a P-EDCA contention and taking this into account when either participating in that contention, or initiating the following P-EDCA contentions.

Furthermore, current proposals consider P-EDCA-contention initiation and P-EDCA-contention participation eligibility criteria to be the same. In other words, the proposal considers that only the STAs which are eligible to send a DS (initiate the P-EDCA contention) may participate in the P-EDCA contention initiated by that DS. However, in some scenarios, it could be beneficial to extend the set of LL-STAs which are eligible to participate in the P-EDCA contention without extending the set of LL-STAs, which are eligible to initiate the contention in the first place.

Embodiments of the present disclosure, which will be described in detail below with reference to the accompanying drawings, address these issues and reduce the tail delays for frame delivery by the LL-STAs.

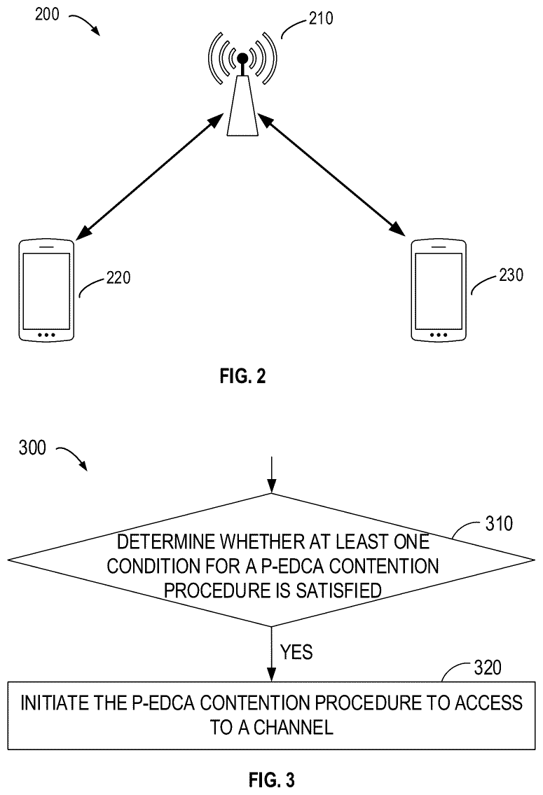

FIG. 2 illustrates an example communication environment 200 in which example embodiments of the present disclosure can be implemented. In the communication environment 200, a network device 210, which may serve as an AP, directly or indirectly communicates with a plurality of terminal devices such as terminal devices 220 and 230. As used herein, a terminal device may be referred to as a station (STA). The network device 210 may be responsible for managing the wireless communication network, coordinating channel access, and providing connectivity to the terminal devices 220 and 230.

The network device 210 may be any suitable device that allows the terminal device 220 and/or terminal device 230 to connect to the wireless communication network in the example environment 200. As used herein, the network device 210 may include, be implemented as, or known as a Radio Router, Radio Transceiver, switch, Wi-Fi hotspot device, Basic Service Set (BSS), Extended Service Set (ESS), Radio Base Station (RBS), or some other terminology.

Examples of the terminal device may include but not be limited to smartphones, laptops, or other wireless-enabled devices that rely on the wireless network provided by the network device 210 such as an AP. These devices may engage in bidirectional data exchange, enabling them to access services such as internet browsing, media streaming, and more. One or both of the terminal devices 220 and 230 may be running latency-sensitive applications such as real-time video streaming, gaming, or VoIP, which require low latency for optimal performance. In other words, the terminal device 220 and/or the terminal device 230 may be implemented as a LL STA that is designed to handle LL traffic, such as real-time communications or video streaming. The network device 210 may manage the overall traffic flow in the network, so as to ensure that the terminal devices 220 and 230 are able to transmit and receive data without undue delays. As used herein, the term “LL traffic” may refer to traffic related to a latency-sensitive application, traffic with a lower latency threshold, traffic with a shorter deadline, and/or traffic with a high priority, or the like.

In some example embodiments, the terminal devices 220 and 230 may perform a channel access contention procedure such as the P-EDCA contention procedure to access to a channel provided by the network device 210 for data transmission and reception. By way of example, the terminal device 220, as a STA, may need to compete with other STAs for channel access to a wireless network provided by the network device 210, for example, a Wi-Fi network. Therefore, the terminal device 220 may experience contention with other LL STA and/or non-LL STA for the wireless network. For the purpose of discussion, some example embodiments regarding the channel access management will be described with respect to the P-EDCA contention procedure. It is to be understood that these embodiments may be applied to any other suitable channel access contention procedure.

It is to be understood that the number of devices and their connections shown in FIG. 2 are only for the purpose of illustration without suggesting any limitation. The communication environment 200 may include any suitable number of devices configured to implement example embodiments of the present disclosure. Although not shown, it would be appreciated that one or more additional devices may be deployed in the communication environment 200. For example, more than two terminal devices may be served by the network device 210 and may perform a channel access contention procedure to the channel provided by the network device 210. It is noted that although illustrated as a network device, the network device 210 may be another device than a network device. Although illustrated as a terminal device, the terminal devices 220 and 230 may be another device than a terminal device.

In the following, for the purpose of illustration, some example embodiments are described with the terminal devices 220 and 230 operating as STAs and the network device 210 operating as an AP. However, in some example embodiments, operations described in connection with a terminal device or STA may be implemented at a network device or other device, and operations described in connection with a network device or AP may be implemented at a terminal device or other device.

In some example embodiments, a transmission direction from the network device 210 to the terminal device 220 or 230 is referred to as a downlink (DL), while a transmission direction from the terminal devices 220 or 230 to the network device 210 is referred to as an uplink (UL). In DL, the network device 210 is a transmitting (TX) device (or a transmitter) and the terminal device 220 or 230 is a receiving (RX) device (or a receiver). In UL, the terminal device 220 or 230 is a TX device (or a transmitter) and the network device 210 is a RX device (or a receiver).

Communications in the communication environment 200 may be implemented according to any proper communication protocol(s), comprising, but not limited to, IEEE 802.11 standards, Wi-Fi Alliance Specifications, or any other wireless communication standards. The IEEE 802.11 standards may include the IEEE 802.11ax standard (also referred to as Wi-Fi 6),, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The present disclosure provides solution(s) for improving traffic delivery, especially for reducing LL traffic delivery delays. In accordance with some example embodiments of the present disclosure, an apparatus determines whether at least one condition for a P-EDCA contention procedure is satisfied. If the at least one condition is satisfied, the apparatus initiates the P-EDCA contention procedure to access to a channel. The at least one condition is based on: information of a previous TXOP, a transmission status of a transmission of the apparatus, and/or a channel contention delay experienced by the apparatus. In this manner, the apparatus such as STA can make a decision on initiating a P-EDCA contention procedure properly.

In accordance with some other example embodiments of the present disclosure, an apparatus receives an indication of a frame exchange sequence within a P-EDCA context. The apparatus determines whether at least one condition for participating in a P-EDCA contention procedure is satisfied. If the at least one condition is satisfied, the apparatus participates in the P-EDCA contention procedure initiated by a further apparatus. In this manner, the apparatus such as a STA can decide whether to participate in a P-EDCA contention procedure initiated by another STA.

As such, significant improvements in the overall efficiency and responsiveness of LL traffic delivery can be achieved. Delays (e.g., the tail delays for frame delivery by the LL-STAs) can be reduced and the reliability of transmissions can be improved, resulting in enhanced performance for time-sensitive applications and better utilization of the network resources. This contributes to a smoother user experience, particularly in high-demand environments where latency is critical.

FIG. 3 illustrates a flowchart of an example method 300 for channel access management in accordance with some example embodiments of the present disclosure. The method 300 may be implemented by a first apparatus or a terminal device. For the purpose of discussion, the method 300 will be described from the perspective of the terminal device 220 in FIG. 1.

At block 310, the terminal device 220 determines whether at least one condition for a P-EDCA contention procedure is satisfied. If the at least one condition is satisfied, at block 320, the terminal device 220 initiates the P-EDCA contention procedure to access a channel. The channel may be provided by a second apparatus such as the network device 210 in FIG. 2. The at least one condition is based on information of a previous TxOP, a transmission status of a transmission of the terminal device 220, and/or a channel contention delay experienced by the terminal device 220. As used herein, the at least one condition may be referred to as at least one condition (or criterion) for initiating the P-EDCA contention procedure, or at least one initiation condition (or criterion) for the P-EDCA contention procedure.

As mentioned, the at least one condition may be based on information of the previous TxOP. For example, the information of the previous TxOP may include a length of the previous TxOP and/or that which apparatus the previous TxOP belongs to. In an embodiment, the at least one condition may include a length of the previous TxOP being longer than a first threshold. For example, if the previous TxOP is longer than the first threshold, at block 320, the terminal device 220 initiates the P-EDCA contention procedure. Another condition may be that the previous TxOP belongs to a further apparatus such as the terminal device 230. Specifically, the terminal device 220 such as an LL STA may be eligible for P-EDCA contention if the previous TxOP was longer than the first threshold and/or that TxOP did not belong to the terminal device 220. With such initiation condition for the P-EDCA contention procedure, collisions of LL STAs with each other and with non-LL STAs can be reduced. For times when the collision probability is high, such embodiments will be benefit for the collision reduction. After long TxOPs, when the probability is high that several STAs not involved in the TxOP will have received traffic awaiting transmission. One of these STAs may initiate the P-EDCA contention procedure.

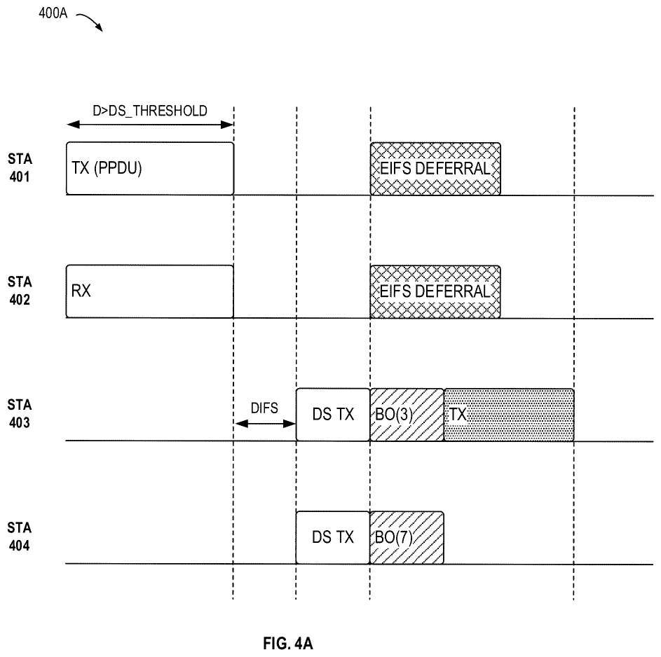

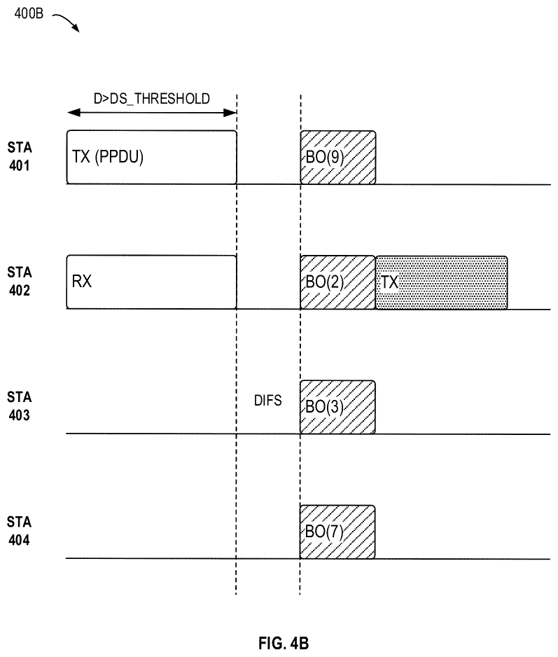

FIG. 4A and FIG. 4B illustrate example diagrams showing the P-EDCA contention initiation eligibility based on the duration of the previous TXOP. FIG. 4A illustrates an example P-EDCA procedure 400A after a long TxOP according to some embodiments of the present disclosure. FIG. 4B illustrates an example P-EDCA procedure 400B after a short TxOP according to some embodiments of the present disclosure. In these figures, STA 401 and STA 402 are non-LL STAs, while STA 403 and STA 404 may be LL STAs.

In FIG. 4A, the first TxOP's duration is longer than a threshold required for P-EDCA. For example, a physical protocol data unit (PPDU) may be transmitted from the STA 401 to the STA 402 in the first TxOP. Thus, if or when the STA 403 and STA 404 get traffic during the TxOP, they are eligible to send DSs to reserve the channel for P-EDCA contention. Then, the STA 403 and STA 404 may send the DSs at the end of the first TxOP.

In contrast, FIG. 4B shows the case in which the LL STA (STA 403 and STA 404) may not initiate P-EDCA when the previous TXOP is shorter than the threshold. In FIG. 4B, all STAs may contend for the channel. Specifically, in FIG. 4B, the first TxOP is not longer than the threshold for initiating P-EDCA contention, thus at the end of the TxOP, none of the STAs are allowed to transmit a DS, and all STAs may contend for the channel using a standard EDCA procedure.

Referring back to FIG. 3, in some example embodiments, the at least one condition may further include the terminal device 220 failing to transmit latency sensitive data. The at least one condition may further include the terminal device 220 failing to transmit a frame before a deadline of the frame. The at least one condition may further include a deferral of a transmission of the terminal device 220 upon a backoff counter reaching zero. In some example embodiments, the at least one condition may further include a channel contention delay experienced by the terminal device 220 being longer than a delay threshold. The at least one condition may further include a condition of a retry counter of the terminal device 220.

In some example embodiments, the at least one condition may further include a block ACK indicating a failure or deferral of a transmission of an MPDU by the terminal device 220. In some example embodiments, the deferral of the transmission of the terminal device 220 may include a deferral of a transmission of an MPDU upon the backoff counter reaching zero in response to the following condition(s). In an example, if a remaining time before a starting point of a following restricted target wake time service period is less than a time duration for the transmission of the MPDU, the terminal device 220 may defer the transmission of the MPDU upon the backoff counter reaching zero. In an example, if the terminal device 220 postpones the beginning of a TxOP on a first link until a second link accessing to a channel and reinitiates a channel access on the first link, the terminal device 220 may defer the transmission of the MPDU upon the backoff counter reaching zero. In an example, if the terminal device 220 transmits a frame with an operation mode control subfield with an uplink multi-user disable subfield set to 1 (or other suitable value) and receives an immediate acknowledgement from an operation mode indication responder, the terminal device 220 may defer the transmission of the MPDU upon the backoff counter reaching zero. In an example, if the terminal device 220 transmits a frame with the uplink multi-user disable subfield set to 0 and an uplink multi-user data disable subfield set to 1 and receives an immediate acknowledgement from an operation mode indication responder, the terminal device 220 may defer the transmission of the MPDU upon the backoff counter reaching zero.

With these conditions, the P-EDCA contention initiation eligibility may further be based on the retransmission status of the MPDU. In addition to considering the QSRC counter value as a criterion for P-EDCA contention eligibility, it is proposed herein several additional criteria may be considered as well. For example, if the terminal device 220 has already attempted to deliver the MPDU but the transmission was unsuccessful as indicated by the received Block Ack, the terminal device 220 may be eligible for P-EDCA contention. For example, if the MPDU belongs to a stream set up between the terminal device 220 (such as the LL STA) and the network device 220, the stream has specified a latency requirement, and the MPDU is experiencing a delay that may lead to a violation of the latency requirement, the STA may be eligible for P-EDCA contention. Furthermore, P-EDCA contention eligibility may be triggered in the following scenario.

In such scenario, the terminal device 220 has already attempted to transmit this MPDU by performing a backoff procedure. However, upon the backoff counter reaching zero, the terminal device 220 decided to defer the transmission. The decision may be made because the time remaining before the start of the following R-TWT SP is not enough to finish the MPDU transmission. Alternatively, or in addition, the decision may be made because when the non-AP multi-link device (MLD) postpones the beginning of a TxOP on one of its links until the other link also gains access to the channel, but for some reason later re-initiates EDCA on that first link. A non-AP STA sends a frame with an operation mode (OM) Control subfield with the UL multi-user (MU) Disable subfield set to 1 or with the UL MU Disable subfield set to 0 and the UL MU Data Disable subfield set to 1 and receives an immediate acknowledgement from the operation mode indication (OMI) responder.

With these conditions, the terminal device 220 such as an LL STA may be eligible to initiate P-EDCA in the following cases: the LL STA has failed to deliver its LL data because of channel estimation error, has experienced long channel contention delay, has an LL frame at risk of missing its deadline, or has recently deferred its transmission despite its backoff counter reaching zero. As such, LL delivery delays resulting from things other than EDCA collisions can be reduced.

Several example conditions for initiating the P-EDCA contention procedure have been described. These conditions may be used separately, or in any combination. Other suitable condition(s) may also be applied for initiating the P-EDCA contention procedure. Embodiments of the present disclosure are not limited here.

These conditions may be based on one or more thresholds. For example, the first condition of the previous TxOP length is based on the first threshold (also referred to as a TxOP duration threshold). In some example embodiments, the first threshold may be predefined. In an example, the threshold may be fixed and indicated directly in the specification. In an example, the threshold may be left up to implementation.

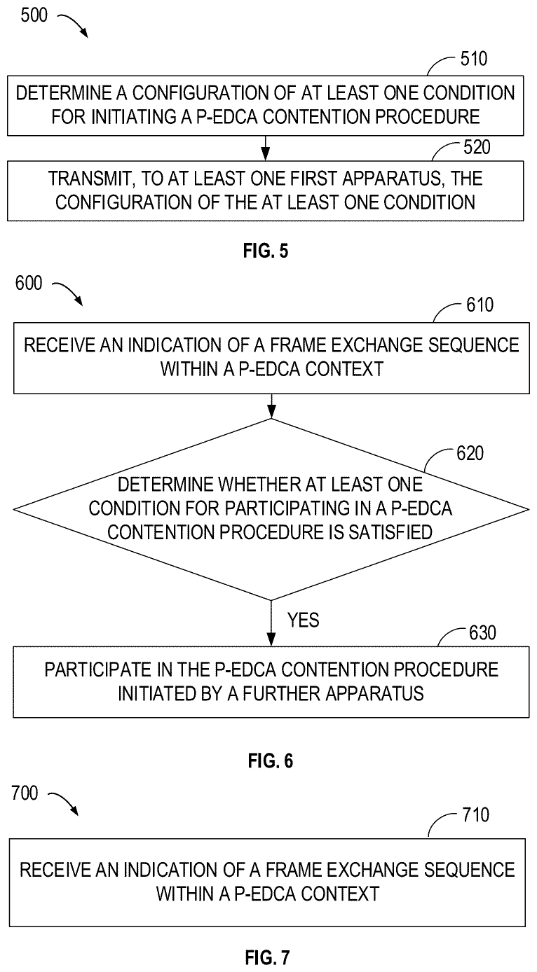

Alternatively, in some example embodiments, the first threshold may be configured by the network device 210. The first threshold may be determined by the network device 210 and indicated to the terminal device 220. Details of the determination of the first threshold will be described with respect to FIG. 5. There may be several options for advertising the first threshold. By way of example, a configuration of the first threshold from the network device 210 may be included in: a beacon frame, a broadcast management frame, a multicast management frame, a unicast management frame, and/or a control or data frame. In an example, the network device 210 may dynamically change the first threshold using the header fields in control or data frames. In some example embodiments, the configuration of the first threshold may be received from the network device 210 during a traffic stream setup procedure. In an example, the network device 210 may communicate the first threshold as a part of the traffic stream setup procedure, for example, via stream classification service (SCS), mirrored stream classification service (MSCS), traffic specification (TSPEC).

In some example embodiments, the terminal device 220 may receive a configuration of the at least one condition from the network device 210. In some example embodiments, the configuration comprises a plurality of thresholds and at least one parameter for selecting a first threshold for a condition for the P-EDCA contention procedure. In such cases, the terminal device 220 may select the first threshold from the plurality of thresholds based on the at least one parameter, such as a queue size of the terminal device 220, a retry counter of the terminal device 220, a delay of a frame to be transmitted by the terminal device 220, a remaining time before a deadline for transmitting a frame by the terminal device 220, a frequency of channel access by the terminal device 220, an average airtime occupied by the terminal device 220, a frequency of P-EDCA contention procedures performed by the terminal device 220, and/or the like.

As described, the condition for initiating the P-EDCA contention procedure may be based on the length (or duration) of a previous TxOP. There are several options for how the terminal device 220 measures the duration of a given TXOP in order to determine whether to initiate the P-EDCA contention. In some example embodiments, the terminal device 220 may determine a length of a previous TXOP based on one or more parameters, such as a duration of a last physical protocol data unit indicated in a physical header, a duration of a last physical protocol data unit indicated in a medium access control header, a duration of a latest medium occupancy according to a virtual carrier sense mechanism, a duration of a latest medium occupancy according to a physical carrier sense mechanism, a duration of a time during which the terminal device 220 is disallowed to access a channel, and/or the like. In some example embodiments, during a restricted target wake time service period for which the terminal device 220 is not associated, the terminal device 220 may be disallowed to access the channel. In some example embodiments, during a quiet interval advertised by the network device 210 connecting with the terminal device 220, the terminal device 220 may be disallowed to access the channel. In an example, the terminal device 220 may use the duration of the last PPDU as signaled in its PHY or MAC header. In an example, the terminal device 220 may use the duration of the latest medium occupancy according to the virtual or physical carrier sense mechanism of the terminal device 220. In an example, the terminal device 220 may use the duration of the time the STA was not allowed to access the channel, such as, a restricted target wake time (R-TWT) SP for which the STA is not a member, or a quiet interval advertised by the AP. The terminal device 220 may use one or any combination of these parameters, including using the maximum value among them.

Example embodiments of the configuration of the first threshold and the selection of the first threshold have been described. It is to be understood that for other threshold used in these P-EDCA contention initiation conditions, similar configuration or selection approaches may be applied.

Embodiments described with respect to FIG. 3 provide improved criteria for P-EDCA eligibility. As such, significant improvements in the overall efficiency and responsiveness of LL traffic delivery can be achieved. Delays (e.g., the tail delays for frame delivery by the LL-STAs) can be reduced and the reliability of transmissions can be improved, resulting in enhanced performance for time-sensitive applications and better utilization of the network resources. This contributes to a smoother user experience, particularly in high-demand environments where latency is critical.

FIG. 5 illustrates a flowchart of an example method 500 for channel access management in accordance with some example embodiments of the present disclosure. The method 500 may be implemented by a second apparatus or a network device. For the purpose of discussion, the method 500 will be described from the perspective of the network device 210 in FIG. 1.

At block 510, the network device 210 determines a configuration of at least one condition for initiating a P-EDCA contention procedure. At block 520, the network device 210 transmits the configuration of the at least one condition to at least one apparatus or device such as the terminal device 220. The at least one condition may be similar or the same to the at least one condition described with respect to the method 300, which will not be repeated here.

The network device 210 may manage channel access requests from a plurality of STAs including the terminal device 220 contending for the wireless network it provides. Therefore, the network device 210 may coordinate contention between the terminal device 220 and other LL STAs or non-LL STAs. In the method 500, the P-EDCA mechanism is utilized for channel access management.

In some example embodiments, if the at least one condition includes a first condition that a length of the previous TXOP is longer than the at least one threshold, the network device 210 may determine at least one threshold for the P-EDCA contention procedure and include the at least one threshold in the confirmation of the at least one condition.

In some example embodiments, the network device 210 may broadcast the configuration in a beacon frame, a broadcast management frame, a multicast management frame, a unicast management frame, and/or a control or data frame. In some example embodiments, the network device 210 may transmit the configuration during a traffic stream setup procedure.

In some example embodiments, the network device 210 may determine the at least one threshold on the following basis: per station, per access category, or per basic service set. That is, the network device 210 may define the first threshold on a per STA, per AC, or per BSS basis.

In some example embodiments, the at least one threshold may include a plurality of thresholds, and the network device 210 may transmit, to the terminal device 220, a configuration of at least one parameter for selecting a threshold for a condition for the P-EDCA contention procedure. In an example, the network device 210 may define several thresholds that may be used concurrently by a STA, depending on some of the variables known to the LL STA before engaging in the contention. Such variables may include conditions and parameters including but not limited to STA queue size, retry counter, the delay experienced by the frame to be transmitted, the time remaining before the frame's delivery deadline, frequency of channel access by the STA, average airtime occupied by the STA, the frequency of P-EDCA contentions, and/or the like.

The threshold definition granularity (per BSS, STA, several per STA) may trade off the complexity of finding the optimal set of threshold values to the flexibility and gains provided by the use of P-EDCA mechanism. For example, the network device 210 may define two thresholds: t1 and t2, where t1<t2. The terminal device 220 may initiate a P-EDCA contention if the previous TxOP duration T>t2. For the terminal device 220 with QSRC greater than 0, the terminal device 220 is allowed to initiate a P-EDCA contention if t1<T<t2. This flexibility allows the network device 210 to better manage the intensity of contention LL STAs experience and the impact of P-EDCA on non-LL STAs.

It is to be understood that although some example embodiments are described with a single network device 210 and a single terminal device 220, in some embodiments, there may be more than one network device and/or more than one terminal device. For example, the network device 210 may transmit the configuration of the at least one condition to a plurality of terminal devices such as the terminal device 220 and the terminal device 230 and the like.

In this way, improved criteria for P-EDCA eligibility can be configured by the network for the STAs. As such, significant improvements in the overall efficiency and responsiveness of LL traffic delivery can be achieved. Delays (e.g., the tail delays for frame delivery by the LL-STAs) can be reduced and the reliability of transmissions can be improved, resulting in enhanced performance for time-sensitive applications and better utilization of the network resources. This contributes to a smoother user experience, particularly in high-demand environments where latency is critical.

FIG. 6 illustrates a flowchart of an example method 600 for channel access management in accordance with some example embodiments of the present disclosure. The method 600 may be implemented by a first apparatus or a terminal device. For the purpose of discussion, the method 600 will be described from the perspective of the terminal device 220 in FIG. 1.

At block 610, the terminal device 220 receives an indication of a frame exchange sequence within a P-EDCA context. At block 620, the terminal device 220 determines whether at least one condition for participating in a P-EDCA contention procedure is satisfied. If the at least one condition for P-EDCA participation is satisfied, at block 630, the terminal device 220 participates in the P-EDCA contention procedure initiated by a further apparatus such as the terminal device 230. If the at least one condition for participating in the P-EDCA contention procedure is not satisfied, the terminal device 220 may not participate in the contention procedure.

In some example embodiments, the indication may be included in a PHY header of a frame and/or a MAC header of the frame. The frame may include a RTS frame, a CTS frame, an ACK frame, a block ACK frame, and/or a data frame.

As such, embodiments of the present disclosure propose a mechanism to indicate that a frame exchange sequence happens within the P-EDCA context. In particular, the indication may be put in either PHY or MAC header of a Wi-Fi frame. The type of frame could be any of the used in the P-EDCA context, including but not limited to data frames and such control frames as RTS, CTS, ACK, Block Ack. This allows a STA to be able to detect P-EDCA-related frame transmissions by the other STAs, to take that into account, and to define a STA's eligibility for initiation and participation in the following P-EDCA contentions.

In some example embodiments, the indication may be indicated by a MAC header field, or a part of an UHR control field in the frame. The indication may introduce the minimal possible changes to the structure of the frames, so that the frames sent within the P-EDCA may be decodable by non-P-EDCA-enabled STAs. For example, the signaling may reuse the existing MAC header fields, such as More Data, More Fragments, etc., or be defined to be a part of an UHR control field.

Due to this new signaling, an LL-STA can detect that another LL-STA initiates a P-EDCA contention. This allows the STA to differentiate the conditions for an LL-STAs to be eligible to initiate or to participate in P-EDCA contention. Additionally, this achieves the management of the tradeoff between the tail latencies of LL traffic delivery and capacity and fairness in the BSS.

In some example embodiments, the at least one condition for participating in the P-EDCA contention procedure may be based on: a channel access frequency of the terminal device 220, an average channel occupancy of the terminal device 220, a retry counter of the terminal device 220, a LL access category of the terminal device 220, a delay experienced by a frame to be transmitted by the terminal device 220 and a latency requirement of the delay, an amount of obtained airtime of the terminal device 220, a number of P-EDCA contention procedures participated by the terminal device 220 in a time window, a queue size of the terminal device 220, a duration of a previous PPDU, a duration of a previous TXOP, and/or a status variable of a frame to be transmitted by the terminal device 220. In some example embodiments, the status variable of the frame to be transmitted by the terminal device 220 may include: a retry status of the frame, a delay budget of the frame, and/or a time length the frame has spent in a queue.

In some example embodiments, the at least one condition for participating in the P-EDCA contention procedure may be predefined. In some example embodiments, the terminal device 220 may receive, from the network device 210, a configuration of the at least one condition for participating in the P-EDCA contention procedure. The configuration may include: the at least one condition, at least one parameter for determining the at least one condition, and/or an indication indicating to enable or disable the at least one condition. In some example embodiments, the configuration may be included in: a beacon frame, a management frame, a control frame, and/or a data frame.

The parameters of P-EDCA contention participation eligibility may be defined on a per STA, per AC, or per BSS basis, and advertised in any of the following ways. The AP may advertise the parameters in beacons or other broadcast, multicast, or unicast management frames. The AP may dynamically change the parameters using the header fields in control or data frames. The AP may communicate the parameters as a part of the traffic stream setup procedure (e.g., via SCS, MSCS, TSPEC). The parameters may be fixed and indicated directly in the specification. The parameters may be left up to implementation.

The P-EDCA contention participation eligibility may be enabled or disabled by the network device 210. It may be subject to a constrained set of LL frames. It may depend on the STA status variables, such as the QSRC counter, amount of obtained airtime, number of P-EDCA contentions in which the STA has participated in a time window, STA queue size, frequency of STA's channel access, the duration of the previous PPDU or TxOP, etc. Finally, it may depend on the status variables of the LL frame to be transmitted, such as, retry status of a frame, its delay budget, time the frame has already spent in the queue, etc.

This allows to increase the channel access priority of a set of LL-STAs the moment any of the LL-STAs starts experiencing the channel access issues. Consequently, this can improve the pace of the issue resolution and avoid accumulation of the issues at many LL-STAs.

Further, P-EDCA contention participation eligibility may further be based on the retransmission status of the MPDU. The criteria may be similar to those described above with respect to the P-EDCA contention initiation eligibility based on the retransmission status of the MPDU, which will not be repeated herein.

In some example embodiments, the at least one condition may include: a block ACK indicating a failure of a transmission of a MPDU by the terminal device 220. In some example embodiments, a deferral of a transmission of a MPDU by the terminal device 220 being longer than a threshold.

In some example embodiments, the deferral of the transmission of the terminal device 220 may include a deferral of a transmission of a MPDU upon the backoff counter reaching zero in response to the following condition(s).

In an example, if a remaining time before a starting point of a following restricted target wake time service period is less than a time duration for the transmission of the MPDU, the terminal device 220 may defer the transmission of the MPDU upon the backoff counter reaching zero.

In an example, if the terminal device 220 postpones a beginning of a TXOP on a first link until a second link accessing to a channel and reinitiates a channel access on the first link, the terminal device 220 may defer the transmission of the MPDU upon the backoff counter reaching zero.

In an example, if the terminal device 220 transmits a frame with an operation mode control subfield with an uplink multi-user disable subfield set to 1 and receives an immediate acknowledgement from an operation mode indication responder, the terminal device 220 may defer the transmission of the MPDU upon the backoff counter reaching zero.

In an example, if the terminal device 220 transmits a frame with the uplink multi-user disable subfield set to 0 and an uplink multi-user data disable subfield set to 1 and receives an immediate acknowledgement from an operation mode indication responder, the terminal device 220 may defer the transmission of the MPDU upon the backoff counter reaching zero.

Several example conditions for participating in the P-EDCA contention procedure have been described. These conditions may be used separately, or in any combination. Other suitable condition(s) may also be applied for the P-EDCA contention participation eligibility. Embodiments of the present disclosure are not limited here.

Therefore, embodiments of the present application provide an effective and efficient approach for differentiation between eligibility for initiating and participating in P-EDCA contention. As such, significant improvements in the overall efficiency and responsiveness of LL traffic delivery can be achieved. Delays (e.g., the tail delays for frame delivery by the LL-STAs) can be reduced and the reliability of transmissions can be improved, resulting in enhanced performance for time-sensitive applications and better utilization of the network resources. This contributes to a smoother user experience, particularly in high-demand environments where latency is critical.

FIG. 7 illustrates a flowchart of an example method 700 for channel access management in accordance with some example embodiments of the present disclosure. The method 700 may be implemented by a second apparatus or a network device. For the purpose of discussion, the method 700 will be described from the perspective of the network device 210 in FIG. 1.

At block 710, the network device 210 transmits, to at least one apparatus such as the terminal device 220, a configuration of the at least one condition for participating in a P-EDCA contention procedure initiated by a further apparatus. The at least one condition may be similar or the same to the at least one condition described with respect to the method 600, which will not be repeated herein.

In some example embodiments, the network device 210 may update the configuration of the at least one condition in a header field in a control frame or a data frame. In some example embodiments, the network device 210 may broadcast or multicast or unicast the configuration of the at least one condition. In some example embodiments, the network device 210 may transmit the configuration of the at least one condition during a traffic stream setup procedure.

In some example embodiments, the network device 210 may transmit, to the terminal device 220, a further configuration of at least one further condition for initiating a P-EDCA contention procedure. The at least one further condition may be different from the at least one condition. The at least one further condition may at least include a first condition that a length of a previous transmission opportunity is longer than a first threshold.

Therefore, embodiments of the present application provide an effective and efficient approach for differentiation between eligibility for initiating and participating in P-EDCA contention. As such, significant improvements in the overall efficiency and responsiveness of LL traffic delivery can be achieved. Delays (e.g., the tail delays for frame delivery by the LL-STAs) can be reduced and the reliability of transmissions can be improved, resulting in enhanced performance for time-sensitive applications and better utilization of the network resources. This contributes to a smoother user experience, particularly in high-demand environments where latency is critical.

It is to be understood that the method 300 and method 600 described above may be applied separately, or in combination by the terminal device 220 and any other suitable terminal device such as the terminal device 230. The role of the terminal device 220 may vary. For example, the terminal device 220 initiates a first P-EDCA contention procedure at a first time point based on the P-EDCA initiation condition may also participate in a second P-EDCA contention procedure initiated by a further terminal device at a second time point based on the P-EDCA participation condition. Likewise, a terminal device participate in the first P-EDCA contention procedure initiated by the terminal device 220 may initiate a further P-EDCA contention procedure. It is also to be understood that the method 500 and method 700 may be applied by the network device 210 separately or in combination. For example, the network device 210 may configure the at least one P-EDCA contention initiation condition (and/or parameters associated with the initiation condition) and the at least one P-EDCA contention participation condition (and/or parameters associated with the participation condition) together in a single message, or separately in different messages.

In some example embodiments, a first apparatus capable of performing any of the method 300 (for example, the terminal device 220 in FIG. 2) may comprise means for performing the respective operations of the method 300. The means may be implemented in any suitable form. For example, the means may be implemented in a circuitry or software module. The first apparatus may be implemented as or included in the terminal device 220 in FIG. 2.

In some example embodiments, the first apparatus comprises means for determining whether at least one condition for a prioritized enhanced distributed channel access (P-EDCA) contention procedure is satisfied; and means for based on the at least one condition being satisfied, initiating the P-EDCA contention procedure to access to a channel, where the at least one condition is based on at least one of: information of a previous transmission opportunity, a transmission status of a transmission of the first apparatus, or a channel contention delay experienced by the first apparatus.

In some example embodiments, a second apparatus capable of performing any of the method 500 (for example, the network device 210 in FIG. 2) may comprise means for performing the respective operations of the method 500. The means may be implemented in any suitable form. For example, the means may be implemented in a circuitry or software module. The second apparatus may be implemented as or included in the network device 210 in FIG. 2.

In some example embodiments, the second apparatus comprises means for determining a configuration of at least one condition for initiating a prioritized enhanced distributed channel access (P-EDCA) contention procedure; and means for transmitting, to at least one first apparatus, the configuration of the at least one condition, where the at least one condition is based on at least one of: information of a previous transmission opportunity, a transmission status of a transmission of the first apparatus, or a channel contention delay experienced by the first apparatus.

In some example embodiments, another first apparatus capable of performing any of the method 600 (for example, the terminal device 220 in FIG. 2) may comprise means for performing the respective operations of the method 600. The means may be implemented in any suitable form. For example, the means may be implemented in a circuitry or software module. The first apparatus may be implemented as or included in the terminal device 220 in FIG. 2.

In some example embodiments, the first apparatus comprises means for receiving an indication of a frame exchange sequence within a P-EDCA context; means for determining whether at least one condition for participating in a prioritized enhanced distributed channel access (P-EDCA) contention procedure is satisfied; and means for based on the at least one condition being satisfied, participating in the P-EDCA contention procedure initiated by a further apparatus.

In some example embodiments, another second apparatus capable of performing any of the method 700 (for example, the network device 210 in FIG. 2) may comprise means for performing the respective operations of the method 700. The means may be implemented in any suitable form. For example, the means may be implemented in a circuitry or software module. The second apparatus may be implemented as or included in the network device 210 in FIG. 2.

In some example embodiments, the second apparatus comprises means for transmitting, to at least one first apparatus, a configuration of the at least one condition for participating in a prioritized enhanced distributed channel access (P-EDCA) contention procedure initiated by a further apparatus, where the configuration comprises at least one of: the at least one condition, at least one parameter for determining the at least one condition, or an indication indicating to enable or disable the at least one condition.

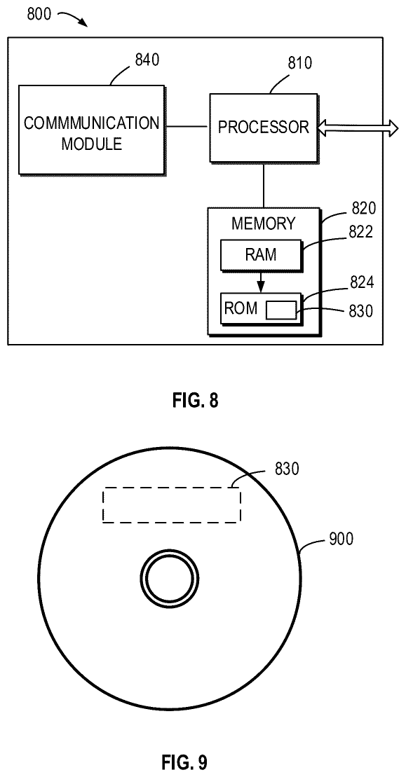

FIG. 8 is a simplified block diagram of a device 800 that is suitable for implementing example embodiments of the present disclosure. The device 800 may be provided to implement a communication device, for example, the terminal device 220 or 230, and/or the network device 210 as shown in FIG. 2. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 3 and FIG. 5 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
determine whether at least one condition for a prioritized enhanced distributed channel access (P-EDCA) contention procedure is satisfied; and
based on the at least one condition being satisfied, initiate the P-EDCA contention procedure to access to a channel,
wherein the at least one condition is based on at least one of:
information of a previous transmission opportunity,
a transmission status of a transmission of the first apparatus, or
a channel contention delay experienced by the first apparatus.

2. The first apparatus of claim 1, wherein the at least one condition comprises at least one of:
a length of the previous transmission opportunity being longer than a first threshold,
the previous transmission opportunity belonging to a further apparatus,
the first apparatus failing to transmit latency sensitive data,
the first apparatus failing to transmit a frame before a deadline of the frame,
a deferral of a transmission of the first apparatus upon a backoff counter reaching zero,
a condition of a retry counter of the first apparatus,
a block acknowledgement indicating a failure of a transmission of a medium access control protocol data unit by the first apparatus, or
a delay of a transmission of a medium access control protocol data unit by the first apparatus being longer than a threshold, or
a channel contention delay experienced by the first apparatus being longer than a delay threshold.

3. The first apparatus of claim 2, wherein the deferral of the transmission of the first apparatus comprises a deferral of a transmission of a medium access control protocol data unit upon the backoff counter reaching zero in response to at least one of:
a remaining time before a starting point of a following restricted target wake time service period being less than a time duration for the transmission of the medium access control protocol data unit,
that the first apparatus postpones a beginning of a transmission opportunity on a first link until a second link accessing to a channel and reinitiates a channel access on the first link,
the first apparatus transmitting a frame with an operation mode control subfield with an uplink multi-user disable subfield set to 1 and receiving an immediate acknowledgement from an operation mode indication responder, or
the first apparatus transmitting a frame with the uplink multi-user disable subfield set to 0 and an uplink multi-user data disable subfield set to 1 and receiving an immediate acknowledgement from an operation mode indication responder.

4. The first apparatus of any of claims 1, wherein the at least one condition comprises that a length of the previous transmission opportunity is longer than a first threshold, and the first threshold is predefined, or configured by a second apparatus.

5. The first apparatus of claim 4, wherein a configuration of the first threshold from the second apparatus is comprised in at least one of: a beacon frame, a broadcast management frame, a multicast management frame, a unicast management frame, or a control or data frame.

6. The first apparatus of claim 4, wherein a configuration of the first threshold is received from the second apparatus during a traffic stream setup procedure.

7. The first apparatus of any of claims 1, wherein the first apparatus is further caused to:
receive, from a second apparatus, a configuration of the at least one condition.

8. The first apparatus of claim 7, wherein the configuration comprises a plurality of thresholds and at least one parameter for selecting a first threshold for a condition for the P-EDCA contention procedure, and wherein the first apparatus is further caused to:
select the first threshold from the plurality of thresholds based on the at least one parameter.

9. The first apparatus of claim 8, wherein the at least one parameter comprises at least one of:
a queue size of the first apparatus,
a retry counter of the first apparatus,
a delay of a frame to be transmitted by the first apparatus,
a remaining time before a deadline for transmitting a frame by the first apparatus,
a frequency of channel access by the first apparatus,
an average airtime occupied by the first apparatus, or
a frequency of P-EDCA contention procedures performed by the first apparatus.

10. The first apparatus of any of claims 1, wherein the first apparatus is further caused to:
determine a length of a previous transmission opportunity based on at least one of:
a duration of a last physical protocol data unit indicated in a physical header,
a duration of a last physical protocol data unit indicated in a medium access control header,
a duration of a latest medium occupancy according to a virtual carrier sense mechanism,
a duration of a latest medium occupancy according to a physical carrier sense mechanism, or
a duration of a time during which the first apparatus is disallowed to access a channel.

11. The first apparatus of claim 10, wherein the time during which the first apparatus is disallowed to access the channel comprises at least one of:
a restricted target wake time service period for which the first apparatus is not associated, or
a quiet interval advertised by a second apparatus connecting with the first apparatus.

12. The first apparatus of any of claims 1, wherein the first apparatus comprises a station accessing to an access point.

13. A second apparatus comprising:
at least one processor; and
at least one memory storing instructions that, when executed by the at least one processor, cause the second apparatus at least to:
determine a configuration of at least one condition for initiating a prioritized enhanced distributed channel access (P-EDCA) contention procedure; and
transmit, to at least one first apparatus, the configuration of the at least one condition,
wherein the at least one condition is based on at least one of:
information of a previous transmission opportunity,
a transmission status of a transmission of the first apparatus, or
a channel contention delay experienced by the first apparatus.

14. The second apparatus of claim 13, wherein the at least one condition further comprises at least one of:
a length of the previous transmission opportunity is longer than a first threshold,
the previous transmission opportunity belonging to a further apparatus,
the first apparatus failing to transmit latency sensitive data,
the first apparatus failing to transmit a frame before a deadline of the frame,
a deferral of a transmission of the first apparatus upon a backoff counter reaching zero,
a condition of a retry counter of the first apparatus,
a block acknowledgement indicating a failure of a transmission of a medium access control protocol data unit by the first apparatus, or
a delay of a transmission of a medium access control protocol data unit by the first apparatus being longer than a threshold, or
a channel contention delay experienced by the first apparatus being longer than a delay threshold.

15. The second apparatus of claim 14, wherein the at least one condition comprises a first condition that a length of the previous transmission opportunity is longer than the at least one threshold, and
wherein the second apparatus is further caused to:
determine at least one threshold for the P-EDCA contention procedure; and
include the at least one threshold in the confirmation of the at least one condition.

16. The second apparatus of claim 15, wherein the second apparatus is further caused to:
determine the at least one threshold on one of the following basis: per station, per access category, or per basic service set.

17. The second apparatus of any of claims 13, wherein the second apparatus comprises an access point, and the at least one first apparatus comprises at least one station accessing to the access point.

18. A method comprising:
determining, at a first apparatus, whether at least one condition for a prioritized enhanced distributed channel access (P-EDCA) contention procedure is satisfied; and
based on the at least one condition being satisfied, initiating the P-EDCA contention procedure to access to a channel,
wherein the at least one condition is based on at least one of:
information of a previous transmission opportunity,
a transmission status of a transmission of the first apparatus, or
a channel contention delay experienced by the first apparatus.

19. A method comprising:
determining, at a second apparatus, a configuration of at least one condition for initiating a prioritized enhanced distributed channel access (P-EDCA) contention procedure; and
transmitting, to at least one first apparatus, the configuration of the at least one condition,
wherein the at least one condition is based on at least one of:
information of a previous transmission opportunity,
a transmission status of a transmission of the first apparatus, or
a channel contention delay experienced by the first apparatus.

20. A computer readable medium comprising instructions stored thereon for causing an apparatus at least to perform the method of claim 19.
